(19) United States
(12) Patent Application Publication
(10) Pub. No.: US 2020/0234169 A1
(43) Pub. Date: Jul. 23, 2020

(54) CONSTRUCTING INTELLIGENT SYSTEM PROCESSING UNCERTAIN CAUSAL RELATIONSHIP TYPE INFORMATION

(71) Applicant: BEIJING TSINGRUI INTELLIGENCE TECHNOLOGY CO., LTD., Beijing (CN)

(72) Inventors: Qin ZHANG, Beijing (CN); Zhan ZHANG, Beijing (CN)

(21) Appl. No.: 16/841,065

(22) Filed: Apr. 6, 2020

Related U.S. Application Data
(63) Continuation of application No. PCT/CN2018/085539, filed on May 4, 2018.

(30) Foreign Application Priority Data
Oct. 17, 2017 (CN) 201710967729.X

(51) Int. Cl. G06N 7/02

(52) U.S. Cl. CPC G06N 7/02

(57) ABSTRACT

Techniques for an intelligent system processing uncertain causal relationship type information are disclosed herein. The disclosed techniques comprise determining, by using a new logic gate and new action variables, an effect of evidences and a combination thereof on the probability of occurrence of a root cause event; determining, by using an universal logic gate, a logic relationship between a cause event and a combination of more than one result event, and performing reasoning; determining, by using a specific event, a corresponding relationship between the specific event and a root cause event, and directly determining a cause when the specific event is observed; determining, by using a degree of attention of a result event, a degree of decrease of a probability that a reasoning result is true due to that the result event cannot be explained by the reasoning result, and involving said degree of attention in probability calculation; and determining, by using a degree of risk of the root cause event, a degree of damage to a system caused by the root cause event, and involving said degree of risk in reasoning calculation.

### CROSS-REFERENCE TO RELATED APPLICATION

This application is a continuation of International Application No. PCT/CN2018/085539, filed on May 4, 2018, which claims priority to Chinese Patent Application No. 201710967729.X, filed on Oct. 17, 2017, the entire contents of which are incorporated herein by reference.

### FIELD OF THE INVENTION

This invention involves the AI technology processing information, and is a further development of the technical schemes recorded in granted Chinese patent METHOD FOR CONSTRUCTING AN INTELLIGENT SYSTEM PROCESSING UNCERTAIN CAUSAL RELATIONSHIP (in Chinese, Patent Number: ZL 2006 8 0055266.X), granted US patent METHOD FOR CONSTRUCTING AN INLLIGENT SYSTEM PROCESSING UNCERTAIN CAUSAL RELATIONSHIP INFORMATION (Patent Number: U.S. Pat. No. 8,255,353 B2), and granted Chinese patent A HEURISTIC CHECK METHOD TO FIND CAUSES OF SYSTEM ABNORMALITY BASED ON DYNAMIC UNCERTAIN CAUSALITY GRAPH (in Chinese, Patent Number: ZL 2016 1 0282052.1). Based on the technical scheme proposed in this invention, through the computations of computer, the ability to represent and utilize causal knowledge of the so-called DUCG (Dynamic Uncertain Causality Graph) can be further improved, to make it more satisfied with the actual demands and to accurately diagnose the cause of abnormality of the object system more conveniently, so as to help people take effective measures to get the current system back to normal.

### BACKGROUND OF THE INVENTION

As granted patents METHOD FOR CONSTRUCTING AN INTELLIGENT SYSTEM PROCESSING UNCERTAIN CAUSAL RELATIONSHIP, METHOD FOR CONSTRUCTING AN INLLIGENT SYSTEM PROCESSING UNCERTAIN CAUSAL RELATIONSHIP INFORMATION and A HEURISTIC CHECK METHOD TO FIND CAUSES OF SYSTEM ABNORMALITY BASED ON DYNAMIC UNCERTAIN CAUSALITY GRAPH recorded, there exist enormous cause events which may lead to the abnormality of systems in industrial systems, social systems and biological systems (abbreviated as object system in the rest of this invention), such as short circuit of coils, fail to stop of pumps, failure of components, malfunction of sub-systems, blocking of transduction pathways, the entry of non-self, the mutation, necrosis, pollution, infection, damage and natural failure of tissues or body. These cause events can be represented by event variable Bₖ or BXₖ indexed by k, Bₖⱼ or BXₖⱼ represents that Bₖ or BXₖ is in state j. As FIG. 1 and FIG. 2 show, Bₖ, Bₖⱼ, BXₖ, and BXₖⱼ can be drawn as graphical symbols such as [symbol] or [symbol] , [symbol] or [symbol] , [symbol] or [symbol] , and [symbol] or [symbol] respectively. The difference between Bₖ and BXₖ is that Bₖ represents root cause variable with no input while BXₖ may have inputs and can be affected by other factors, that is to say, BXₖ means the Bₖ affected by other factors. In general, j=0 means that Bₖ or BXₖ is in the normal state, and j=1, 2, 3 . . . means that Bₖ or BXₖ is in the abnormal state indexed by j.

If there is only one index in the graphical symbol, it indexes the variable and its state is unknown. For simplicity, the two indices kj can be separated by a comma as k,j (the same in what follows).

Most of the states of Bₖ and BXₖ cannot be or are hard to be detected directly, thus the DUCG intelligent system is needed to reason whether Bₖ and BXₖ are in any abnormal state.

Furthermore, there are a large number of variables that are causal to Bₖ or BXₖ such as temperature, pressure, flow, velocity, frequency, switch state, various laboratory reports or physical test results, investigation reports, imaging examination results, feeling, symptom, sign, region, time, environment, season, religion, skin color, experience, sibship, hobby, personality, living condition, working condition and so on. These are called causal variable, represented by X_{y}, in which y=0, 1, 2 . . . while X_{yg} represents the state of X_{y} indexed by g. in general, g=0 means that X_{y} is in the normal state, and g≠0 means that X_{y} is in an abnormal state. X-type variable has at least one input (cause) variable and can have or have no output (consequence) variables. As FIG. 1 and FIG. 2 show, X_{y} and X_{yg} can be drawn as graphical symbols [symbol] or [symbol] , [symbol] or [symbol] respectively.

Based on the DUCG technical theme, people can get Evidence E by detecting the states of X-type variables, to diagnose corresponding Bₖ, or BXₖⱼ (j≠0) that is the root cause of the system abnormality, so as to take effective measures to get the system back to normal. E is composed of at least one state-known X-type variable, e.g. E=X_{1,2}X_{2,3}X_{3,1}X_{4,0}X_{5,0}.

The DUCG intelligent reasoning is to calculate Pr{Hₖⱼ|E}=Pr{HₖⱼE}/Pr{E}, where Hₖⱼ is a hypothesis event, which is a state combination of the variables defined in DUCG, for example, H_{1,2}=B_{1,2}, H_{2,1}=BX_{2,1}, H_{3,2}=BX_{3,2}X_{4,1}, etc., and subscript k in Hₖⱼ indexes the variable combination, e.g. H₁=B₁, H₂=BX₂, H₃=BX₃X₄, etc., subscript j in Hₖⱼ indexes the state combination of the variables in Hₖ, as illustrated above. Denote the set of all hypothesis events Hₖⱼ conditioned on E as S_{H}, i.e. Hₖⱼ∈S_{H}.

The following variables are also defined in DUCG:

Logic gate variable, which has at least two input variables and one output variable, can be represented by Gᵢ. Gᵢⱼ is state j of Gᵢ. Gᵢ is used to represent the logic combinations of input variable states in concern, and these logic combinations are specified by logic gate specification LGSᵢ. For example, G₁ is specified by LGSᵢ: G_{1,1}=B_{3,1}X_{1,1}, G_{1,2}=B_{3,1}X_{1,2}, G_{1,0}=Remnant State that is defined as all other state combinations, etc. Assume GᵢⱼGᵢⱼ=0 (null set, where j≠j′), that is to say, different states of G are mutually exclusive. Similarly, Gᵢ and Gᵢⱼ can be represented by graphical symbols [symbol] or [symbol] , [symbol] or [symbol] respectively.

Default cause variable of X can be represented by Dᵢ. For example, D₄ is the default cause variable of X₄. It is assumed that Pr{Dᵢ}=1. As FIG. 1 depicts, Dᵢ can be represented as graphical symbol [symbol] or [symbol] .

DUCG is comprised of the above-mentioned variables and the certain/uncertain causal relationship between them, which is usually represented by graphical symbols. An example of DUCG is illustrated in FIG. 1, in which B-type variable or event is drawn as rectangle, and X-type variable or event is drawn as circle, and BX-type variable or event is drawn as double-circle, and G-type variable or event is drawn as gate with a directed arc such as [symbol] to connect its input, and D-type variable or event is drawn as pentagon.

{B-, X-, BX-, D-, G-}-type variables/events are also called nodes. Their states can be defined according to the described object. All of {B-, X-, BX-, D-, G-}-type variables/events can be a direct cause variable/event called parent variables/events, and can be represented by V in general, i.e. V∈{B, X, BX, D, G}, with the same subscript. For example, V₂=X₂, V_{3,2}=B_{3,2}, etc. Consequence variable/event can only be {X-, BX-}-type variables/events. A state-known variable is an event, for example, X_{yg}, Bₖⱼ, BXₖⱼ, Gᵢⱼ, Hₖⱼ, and Vᵢⱼ are all events.

A DUCG is comprised of the above-mentioned variables along with the certain/uncertain causal relationships among them. An example of DUCG is illustrated in FIG. 1, in which the directed arc [symbol] is from cause to consequence, denoting the functional variable F_{n;i} representing the causal relationship between parent variable Vᵢ and child variable Xₙ or BXₙ. In F_{n;i}, which is an event matrix, F_{nk;ij} is a member representing the causal relationship between parent event Vᵢⱼ and child event Xₙₖ or BXₙₖ, F_{nk;i} represents the causal relationship between parent variable Vᵢ and child event Xₙₖ or BXₙₖ, F_{n;ij}, represents the causal relationship between parent event Vᵢⱼ and child variable Xₙ or BXₙ, and F_{nk;i} represents the causal relationship between parent event Vₙₖ and child variable Xᵢ or BXᵢ. In details, F_{nk;ij}(r_{n;i}/rₙ)A_{nk;ij}, where r_{n;i}>0 quantifies the uncertain causal relationship intensity between parent variable Vᵢ and child variable Xₙ or BXₙ, rₙ≡Σᵢr_{n;i}, A_{nk;ij} represents the virtual random causal event that Vᵢⱼ may cause Xₙₖ or BXₙₖ and the probability of A_{nk;ij} is defined as a_{nk;ij}≡Pr{A_{nk;ij}} satisfying Σₖ a_{nk;ij}≤1. Define f_{nk;ij}=Pr{F_{nk;ij}}(r_{n;i}/rₙ)a_{nk;ij}, in which f_{nk;ij} means the probabilistic contributions from Vᵢⱼ to Xₙₖ, satisfying

$$Pr \{ {X}_{nk} \} {\sum }_{i , j}^{ } {f}_{nk ; ij} Pr \{ {V}_{ij} \} .$$

In general, vᵢⱼ=Pr{Vᵢⱼ}, in which v∈{b, x, bx, d, g}, and Vᵢⱼ or vᵢⱼ is a member of event vector Vᵢ or parameter vector vᵢ respectively. When cause variable is Dᵢ, define F_{nk;ij}≡F_{nk;iD}, i.e. j=D. The other causal variables and relationships can be represented similarly.

F_{nk;ij} can also be a conditional functional event, which can be drawn as dashed directed arc [symbol] . The conditional functional event is used to represent the conditional functional relationship between its cause event and its consequence event Xₙₖ/BXₙₖ. The condition event Z_{nk;ij} encoded in [symbol] determines whether F_{nk;ij} holds or not. Taken Z_{nk;ij}=X_{1,2} as an example, when X_{1,2} is observed as true, Z_{nk;ij} is met and F_{nk;ij} is held; when X_{1,2} is observed as false, Z_{nk;ij} is not met and F_{nk;ij} is not held. Condition events Z_{nk;ij} can be a single event Z_{n;i}, e.g. Z_{n;i},=X_{1,2}. When X_{1,2} is observed as true, Z_{n;i} is met and F_{n;i} is held, causing [symbol] to become [symbol] ; when X_{1,2} is observed as false, Z_{n;i} is not met and F_{n;i} is not held, causing [symbol] to be eliminated.

For simplicity, the complete set is denoted as 1 and the null set is denoted as 0. Users can also choose other graphical symbols or signs to represent the aforementioned variables and their states.

With the received evidence E, the following rules can be used to simplify the DUCG:

Rule 1: If E shows that Z_{nk;ij} or Z_{n;i} is not met, F_{nk;ij} or F_{n;i} is eliminated from the DUCG. If E shows that Z_{nk;ij} or Z_{n;i} is met, the dashed F_{nk;ij} or F_{n;i} becomes the solid F_{nk;ij} or F_{n;i}.
Rule 2: If E shows that Vᵢⱼ (V∈{B, X}) is true while Vᵢⱼ is not a parent event of Xₙ or BXₙ, F_{n;i} is eliminated from the DUCG.
Rule 3: If E shows that Xₙₖ is true while Xₙₖ cannot be caused by any state of Vᵢ, V∈{B, X, BX, G, D}, F_{n;i} is eliminated from the DUCG, except that Xₙₖ is a descendant of a variable whose state is to be determined and there is no state-known variable to block them.
Rule 4: If E shows that state-unknown {B-, X-}-type node does not have any output directed arc, the node and all its input directed arcs are eliminated from the DUCG.
Rule 5: If E shows Xₙ₀ is true, and Xₙ₀ has no causal connection with abnormal evidence E′, then Xₙ₀ is eliminated from the DUCG, except that Xₙ₀ is a descendant of a variable whose state is to be determined and there is no state-known variable to block them.
Rule 6: If E shows that a group of state-known nodes have no causal connection with Xₙₖ (k≠0), unless through Xₙ₀, then this group of state-known nodes and their connected directed arcs and D-type nodes are eliminated from the DUCG.
Rule 7: If Gᵢ without any output is encountered for any reason, Gᵢ and its input directed arcs [symbol] are eliminated from the DUCG; If Gᵢ without input is encountered, Gᵢ and its output directed arcs are eliminated from the DUCG.
Rule 8: If a directed arc has no parent nodes or no child nodes, then it is eliminated from the DUCG.
Rule 9: If there is such a group of nodes and directed arcs that have no causal connection with those nodes included in E, this group of nodes and connected directed arcs can be eliminated from the DUCG.
Rule 10: If E shows that abnormal state Xₙₖ is true while Xₙₖ does not have any input due to any reason, add a virtual parent event Dₙ to Xₙₖ as its input, in the directed arc from Dₙ to Xₙₖ, a_{nk;nD}=1 and a_{nk;nD}=0 (k≠k′) and r_{n;D}, can be any value. Dₙ can be drawn as [symbol] or [symbol] .
Rule 11: If E shows that there exists a group of state normal X-type events Xₙ₀∈S_{I}(0 indexes normal state), which are connected to only state-unknown variables but not the hypothesis event Hₖⱼ in concern, the state-known variables are blocked by Xₙ₀∈S_{I} with the state-unknown variables, then this group of state-unknown variables and Xₙ₀∈S_{I} are eliminated.
Rule 12: The above rules can be applied in any order: separately, together or repeatedly.

By assuming that only one B-type variable exist while the others do not exist, the simplified DUCG graph can be divided as a group of sub-DUCGs with each containing only one B-type variable. The sub-DUCGs can be simplified according to the above simplification rules again. After these simplifications, the sub-DUCG whose B-type or BX-type variable has no descendent abnormal evidence is eliminated. The abnormal states of the B-type and BX-type variables in the remnant sub-DUCGs make up the possible hypothesis space S_{H} which may lead to system abnormality. S_{H} usually consists of Bₖⱼ or BXₖⱼ (k≠0). For Hₖⱼ∈S_{H}, calculate the posterior probability of Hₖⱼ=Bₖⱼ or Hₖⱼ=BXₖⱼ (k≠0): hₖⱼ^{s}=ξₖPr{Hₖⱼ|E, sub-DUCGₖ}, in which

$${ξ}_{k} = {ζ}_{k} / {\sum }_{k}^{ } {ζ}_{k} ,$$

and ζₖ=Pr{E|sub-DUCGₖ}. According to hₖⱼ^{s}, people can know the possible causes and their ranks of system abnormality, so as to take corrective measures to make the system back to normal as soon as possible.

In order to collect evidence more effectively, granted Chinese patent A HEURISTIC CHECK METHOD TO FIND CAUSES OF SYSTEM ABNORMALITY BASED ON DYNAMIC UNCERTAIN CAUSALITY GRAPH (in Chinese, Patent Number: ZL 2016 1 0282052.1) proposes a method to recommend detecting the states of state-unknown X-type variables, thus to make the above-mentioned evidence ampler and more effective, in order to diagnose and reason more accurately. In the Claim 5 of the above patent, when calculating the probability importance measurement ρᵢ of state-to-test Xᵢ, many calculation formulas are adopted, such as:

$${ρ}_{i} ( y ) = \frac{1}{{m}_{i} ( y )} {\sum }_{k ∈ {S}_{iK} ( y )}^{ } {ω}_{k} {\sum }_{j ∈ {S}_{kJ}}^{ } {\sum }_{g ∈ {S}_{iG} ( y )}^{ } Pr \{ {X}_{ig} \vert E ( y ) \} \vert Pr \{ {H}_{kj} \vert {X}_{ig} E ( y ) \} - Pr \{ {H}_{kj} \vert E ( y ) \} \vert$$

In which, y=0, 1, 2, . . . indexes the step of check, ωₖ is irrelevant to subscript j, that means ωₖ is irrelevant to the abnormal state of root cause variable. In reality, however, the degree of concern for different abnormal states of root cause variable may be different.

The above technical schemes have following restrictions: (1) GᵢⱼG_{ij′}=0 (j≠j′), which is a strict requirement for representing logic combinations. When people only take into account the impact of the combination of different factors Xₙₖ on the probabilistic distribution of each state of Bᵢ, they want a more flexible combination, without or less restricted by the above assumption.

$${\sum }_{k} {a}_{nk ; ij} \leq 1 , \qquad ( 2 )$$

which indicates a_{nk;ij}≤1. However, sometimes the meaning of parameter a is the increasing or decreasing rate of the occurrence probability of an event, thus both a_{nk;ij} and

$${\sum }_{k} {a}_{nk ; ij}$$

can be larger than 1. (3) Logic gate G only considers the state combinations of its input variables, while sometimes people need to represent the state combinations of the output variables of logic gate G. (4) There exists special kind of X-type variable in real applications, once its abnormal state is observed, its corresponding B-type or BX-type cause event can be determined, no complex probabilistic reasoning is needed. (5) The reasoning of DUCG is based on E, yet sometimes the abnormality of state of X-type variable is not caused by current B-type or BX-type variable but caused by other unknown cause. For different states of different X-type variables, the degree that people consider them are different. Thus the concern degree of Xₙₖ (k≠0) and the corresponding calculation method need defining, so that when other conditions are the same, the more unexplained X-type evidence with an abnormal state, the less likely its corresponding B-type or BX-type variable will be the cause of the system abnormality.

This invention proposes an extended technical scheme to solve the aforementioned issues.

### TECHNICAL REFERENCES FOR THIS INVENTION

[1] Q. Zhang and Z. Zhang. Method for constructing an intelligent system processing uncertain causal relationship information, ZL 200680055266.X, 2010, (in Chinese).
[2] Q. Zhang and Z. Zhang. Method for constructing an intelligent system processing uncertain causal relationship information, U.S. Pat. No. 8,255,353 B2, 2012.
[3] Q. Zhang and C. Dong. Method for constructing cubic DUCG for dynamic fault diagnosis, CN 2013107185964, 2015, (in Chinese).
[4] Q. Zhang. A heuristic check method to find causes of system abnormality based on Dynamic Uncertain Causality Graph, Z L 2016 1 0282052.1, 2016, (in Chinese).
[5] Q. Zhang. “Dynamic uncertain causality graph for knowledge representation and reasoning: discrete DAG cases”, Journal of Computer Science and Technology, vol. 27, no. 1, pp. 1-23, 2012.
[6] Q. Zhang, C. Dong, Y. Cui and Z. Yang. “Dynamic uncertain causality graph for knowledge representation and probabilistic reasoning: statistics base, matrix and fault diagnosis”, IEEE Trans. Neural Networks and Learning Systems, vol. 25, no. 4, pp. 645-663, 2014.
[7] Q. Zhang. “Dynamic uncertain causality graph for knowledge representation and probabilistic reasoning: directed cyclic graph and joint probability distribution”, IEEE Trans. Neural Networks and Learning Systems, vol. 26, no. 7, pp. 1503-1517, 2015.
[8] Q. Zhang. “Dynamic uncertain causality graph for knowledge representation and probabilistic reasoning: continuous variable, uncertain evidence and failure forecast”, IEEE Trans. Systems, Man and Cybernetics, vol. 45, no. 7, pp. 990-1003, 2015.
[9] Q. Zhang and S. Geng. “Dynamic uncertain causality graph applied to dynamic fault diagnosis of large and complex systems”, IEEE Trans. Reliability, vol. 64, no. 3, pp 910-927, 2015
[10] Q. Zhang and Z. Zhang. “Dynamic uncertain causality graph applied to dynamic fault diagnoses and predictions with negative feedbacks”, IEEE Trans. Reliability, vol. 65, no. 2, pp 1030-1044, 2016.
[11] Q. Zhang & Q. Yao. Dynamic Uncertain Causality Graph for Knowledge Representation and Reasoning: Utilization of Statistical Data and Domain Knowledge in Complex Cases. IEEE Trans. Neural Networks and Learning Systems, vol. 20, no. 5, pp 1637-1651, 2018.

### DISCLOSURE OF THE INVENTION

This invention discloses a technical scheme, which further develops granted Chinese patents No. CN 200680055266.X and No. CN 2013107185964, and granted U.S. Pat. No. 8,255,353 B2 and the DUCG technical schemes disclosed in the above-mentioned literature.

Detailed Descriptions of the Technical Scheme of this Invention:

1. A method of construction and reasoning of an extended DUCG intelligent system for processing uncertain causal relationship information, by using a storage medium characterized in that: the storage medium stores computer programs, when the computer programs are executed by a computing device comprising at least one processor and at least one memory, they can execute the method that, based on previous DUCG technical schemes, adds new methods to represent and reason the cause Bₖ of object system abnormality, which include (1) Use a new type of logic gate SGₖ and a new functional variable SA_{k;k} to represent the direct influences of evidence X_{yg} and its combinations on every state of Bₖ, Bₖ after the influences is denoted as BXₖ, X_{y} and Bₖ are inputs of SGₖ, and event matrix SA_{k;k} is the output of SGₖ, the member event of SA_{k;k} is SA_{kj;kn}; (2) Use reversal logic gate RGᵢ to represent the logic relationship between every state of cause variable and the state combination of more than one consequence variable, and determine the state of the reversal logic gate based on the meaningful state combination evidence of consequence variables, then make the DUCG reasoning according to the determined state of the reversal logic gate; (3) Use SX_{y} variable to represent the special X-type variable that corresponds to an abnormal state of a certain B-type variable, characterized in that when SX_{yg} (g≠0) is observed, it can be concluded that the corresponding abnormal state of the B-type variable is true without reasoning or calculating about SX_{yg}; (4) Use concern degree ε_{yg} (g≠0) of X_{yg} or SX_{yg} to represent the degree of the decreased likelihood when X_{yg} or SX_{yg} cannot be explained by a reasoning result Hₖⱼ, and includes ε_{yg} in the calculation of the state probability of Hₖⱼ, so that the more ε_{yg} included in the calculation and the bigger the value of ε_{yg}, the smaller the possibility of Hₖⱼ is; (5) Use danger degree μₖⱼ of abnormal state Bₖⱼ of Bₖ to represent the degree of Bₖⱼ to damage the object system, so that the bigger the value of μₖⱼ, the larger the demand to detect the states of X-type variables helpful to determine the state of Bₖ is.

2. As the said 1(1), which also characterized in that: 1) When Bₖ=Bₖⱼ, then BXₖ=BXₖⱼ and vice versa; 2) Use a graphical symbol to represent SGₖ, and a type of directed arc to represent the input relationship from Bₖ or X_{y} to SGₖ; 3) Use another type of directed arc to represent SA_{k;k} from SGₖ to BXₖ; 4) sa_{kj;kn}≡Pr{SA_{kj;kn}} represents the zoom ratio to increase or decrease Pr{Bₖⱼ} as Pr{BXₖⱼ}, sa_{kj;kn} is not restricted by Pr{SA_{kj;kn}}≤1; 5) SA_{k;k} can be a conditional event matrix, which is represented by a directed arc different from the directed arc in the said 3), pointing from SGₖ to BXₖ, the conditional event of SA_{k;k} is represented by Z_{k;k}, which is an observable event, when Z_{k;k} is not met, SA_{k;k} is eliminated, otherwise is kept as ordinary SA_{k;k}; 6) In the logic gate specification LGSₖ of SGₖ, use event combination expression indexed by n (n≠1) to represent the X-type input event combination of SGₖₙ; 7) When n=1, the input event combination of SGₖ₁ is the remnant state of other state combination of input variables, the remnant state can also be indexed by n≠1; 8) n is given to indicate the rank of priorities of expressions; 9) According to the X-type evidence collected on site, match the event combination expression according to the rank of n to determine SGₖ=SGₖₙ, stop the match once an event combination expression indexed by n is matched; 10) When the event combination expression indexed by a special n such as n=0 is matched, Bₖ does not exists, and Bₖ, SGₖ and its input/output directed arcs can be eliminated; 11) The directed arc pointing from the state-unknown or state-normal X-type variable not included in the matched event combination expression n to SGₖₙ can be eliminated; 12) When the matched n is not the special index mentioned above, replace Pr{Bₖⱼ|E} with Pr{BXₖⱼ|E}, BXₖⱼ=SA_{kj;kn}Bₖⱼ, thus Pr {Bₖⱼ|E}=sa_{kj;kn}bₖⱼ, where E is the collected evidence.

3. As the said 1(2), which also characterized in that: 1) Use a graphical symbol to represent RGᵢ, with at least one input variable connected with an F-type directed arc pointing from the input variable to RGᵢ, and with at least two output variables connected with directed arcs pointing from RGᵢ to the output variables; 2) RGᵢₙ is the state of RGᵢ indexed by n, represents the output variable state combination indexed by n, and is denoted as event combination expression n; 3) In the process of reasoning, the DUCG logic expanding of RGᵢₙ is as an X-type variable; 4) When n is a special index such as 0, which means no meaningful state combination of output variables, then RGᵢ₀ and its input/output directed arcs are eliminated; 5) n is given to indicate the rank of the priorities of the output variable state combinations, when evidence E is received, match the state combination expression of RGᵢₙ according to the rank of n till matched to determine RGₖ=RGₖₙ; 6) The a parameters encoded in the output F-type directed arc of RGᵢ can be generated automatically according to the LGSᵢ of RGᵢ. The rule of generation is: Check if there exists X_{yg} in the event combination expression of RGᵢ, if yes then a_{yg;in}=1 that is A_{yg;in}=1, otherwise a_{yg;in}=0 or “-” which means A_{yg;in}=0.

4. As the said 1(3), which also characterized in that: use 1≥θ_{yg}>0 to denote how much confidence of SX_{yg} to determine that an abnormal state of Bₖⱼ, j≠0 (indicate abnormal state), is true directly. θ_{yg} is used as hₖⱼ^{s} to join the rank of possible hypotheses.

5. As the said 1(4), which also characterized in that: 1) ε_{yg} is included in the calculation of the state probability hₖⱼ^{s} of Hₖⱼ, only when Hₖⱼ cannot be the cause explaining X_{yg} or SX_{yg} in sub-DUCGₖ. 2) The way to include ϵ_{yg} in the calculation is: in the calculation of the weighting coefficient

$${ξ}_{k} = {ζ}_{k} / {\sum }_{k}^{ } {ζ}_{k}$$

in the sub-DUCGₖ containing Hₖⱼ, when calculating ζₖ,

$${ζ}_{k} = Pr \{ {\prod }_{{y}^{′} ∈ {S}_{1}}^{ } {E}_{{y}^{′}} \vert sub \text{-} {DUCG}_{k} \} {\prod }_{y ∈ {S}_{2}}^{ }$$

(expression that the bigger ε_{yg}, the smaller the value is), where S₁ represents the set of index of evidence that is explained by Hₖⱼ in the sub-DUCGₖ, and S₂ represents the set of index of X_{yg}-type or SX_{yg}-type evidence that is not explained by Hₖⱼ in the sub-DUCGₖ.

6. As the said 1(5), which also characterized in that: 1) When calculating the probability importance measurement ρᵢ of the Xᵢ variable to be detected, replace ωₖ with ωₖⱼ. 2) When calculating the probability importance measurement ρᵢ, put ωₖⱼ into the inner layer of subscript j in the formulas to calculate ρᵢ, which includes but are not limited to:

$${ρ}_{i} ( y ) = \frac{1}{{m}_{i} ( y )} {\sum }_{k ∈ {S}_{iK} ( y )}^{ } {ω}_{k} {\sum }_{j ∈ {S}_{kJ}}^{ } {\sum }_{g ∈ {S}_{iG} ( y )}^{ } Pr \{ {X}_{ig} \vert E ( y ) \} \vert Pr \{ {H}_{kj} \vert {X}_{ig} E ( y ) \} - Pr \{ {H}_{kj} \vert E ( y ) \} \vert$$

is replaced with

$${ρ}_{i} ( y ) = \frac{1}{{m}_{i} ( y )} {\sum }_{k ∈ {S}_{iK} ( y )}^{ } {\sum }_{j ∈ {S}_{kJ}}^{ } {ω}_{kj} {\sum }_{g ∈ {S}_{iG} ( y )}^{ } Pr \{ {X}_{ig} \vert E ( y ) \} \vert Pr \{ {X}_{ig} E ( y ) \} - Pr \{ E ( y ) \} \vert$$

$$or$$

$${ρ}_{i} ( y ) = \frac{1}{{m}_{i} ( y )} {\sum }_{k ∈ {S}_{iK} ( y )}^{ } \frac{1}{{J}_{k}} {\sum }_{j ∈ {S}_{kJ}}^{ } {ω}_{kj} {\sum }_{g ∈ {S}_{iG} ( y )}^{ } Pr \{ {X}_{ig} \vert E ( y ) \} \vert Pr \{ {X}_{ig} E ( y ) \} - Pr \{ E ( y ) \} \vert$$

where Jₖ denotes the number of abnormal states of Bₖ.

### BRIEF DESCRIPTIONS OF FIGURES

FIG. 1: An example of DUCG.

FIG. 2: Simplified FIG. 1 based on received evidence E=X_{6,2}X_{7,1}X_{14,1}.

FIG. 3: New type of DUCG in Example 3.

FIG. 4: The case of FIG. 3 conditional on E=X_{1,1}X_{2,1}.

FIG. 5: The case of Example 2 after receiving evidence.

FIG. 6: Simplified FIG. 5 according to Claim 2-9).

FIG. 7: FIG. 3 after receiving evidence E=1.

FIG. 8: The further simplification result of FIG. 7.

FIG. 9: The further simplification result of FIG. 8.

FIG. 10: The further simplification result of FIG. 8.

FIG. 11: The case of SA_{k;k} as a conditional functional variable.

FIG. 12: The case of SA_{k;k} being eliminated.

FIG. 13: An example of the reversal logic gate.

FIG. 14: FIG. 13 after receiving evidence E=X_{1,1}X_{2,1}X_{4,1}X_{5,1}.

FIG. 15: Another example of the reversal logic gate.

FIG. 16: FIG. 15 after receiving evidence E=X_{1,1}X_{2,1}X_{4,1}X_{5,1}.

FIG. 17: sub-DUCG after receiving evidence E=X_{2,1}X_{4,1}X_{5,1}SX_{8,1}.

FIG. 18: The simplified sub-DUCG conditioned on E=X_{1,1}X_{2,1}X_{4,1}X_{5,1}X_{6,2}X_{7,1}.

FIG. 19: The subgraph of nasal septum deviation in the DUCG of nasal obstruction.

FIG. 20: The subgraph of encephalomeningocele in the DUCG of nasal obstruction.

FIG. 21: The DUCG of nasal obstruction.

FIG. 22: The graphical explanation to the diagnostic result of case 1 in example 9.

FIG. 23: A realistic example system that may be used in some embodiments.

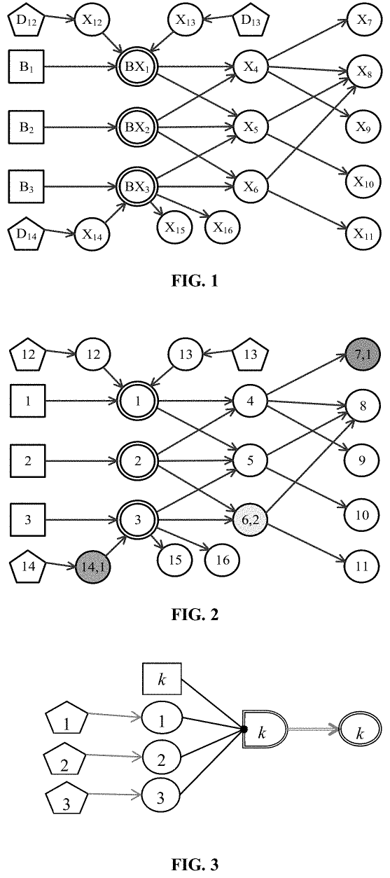

### EXAMPLES OF IMPLEMENTING THIS INVENTION

### Example 1

As is shown in FIG. 3, SGₖ is represented by graphical symbol [symbol] , SGₖⱼ is represented by graphical symbol [symbol] , and its input directed arc is represented by [symbol] , SA_{k;k} is represented by directed arc [symbol] . In Bₖⱼ and BXₖⱼ, it is assumed that j∈{0, 1, 2}. As claimed in Claim 1(2) and Claim 2, X₁, X₂, X₃, and Bₖ comprise the input variables of SGₖ, BXₖ is the output variable of SGₖ connected by SA_{k;k}. Encoded in FIG. 3, the logic expressions LGSₖ (in TABLE 1), the parameter of SA_{k;k}, and the parameters of Bₖ are:

TABLE 1
LGSₖ in FIG. 3

| n | SGₖₙ |
|---|---|
| 0 | X_{1, 0}∪X_{2, 0}X_{3, 0} |
| 1 | Remnant state |
| 2 | X_{1, 1}X_{2, 1} |
| 3 | X_{1, 1}X_{3, 1} |
| 4 | X_{1, 1}X_{2, 1}X_{3, 1} |

where n=0 is the special index;
In FIG. 3, the parameters of Bₖ is: bₖ=(−0.01 0.002)^{T}, and the parameters of SA_{k;k} are Sa_{k;k}:

$${sa}_{k ; k} = ( \begin{matrix}- & - & - & - & - \\ - & 1 & 10 & 15 & 0.5 \\ - & 1 & 2 & 2.5 & 15\end{matrix} ) ,$$

where “-” represents not in concern (equivalent to 0), the meaning of sa_{kj;kn} is: In the case that the state combination of input X-type variables of double-line logic gate SGₖ is determined as the event combination expression n of LGSₖ based on evidence E, the value Pr{Bₖⱼ}=bₖⱼ is decreased/increased to Pr{BXₖⱼ}, in other words, for each E, only one column parameters in sa_{k;k} is included in calculations, e.g. when n=2 is determined based on E, only sa_{k;k2} (−10 2)^{T} is included in calculations.

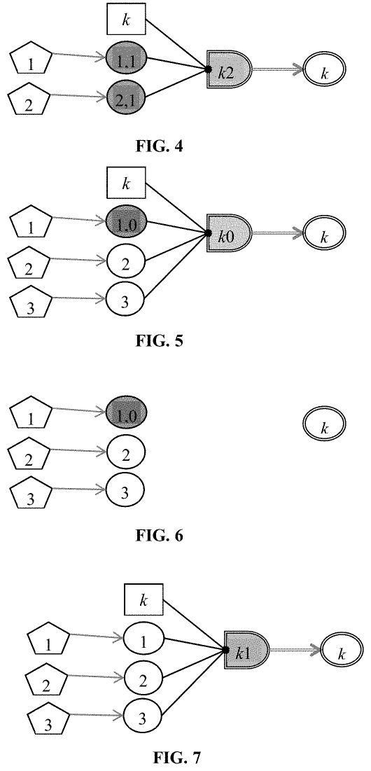

Assume Hₖⱼ=Bₖⱼ, E=X_{1,1}X_{2,1}, and the rank of n is 0, 3, 2, and 1. According to Claim 2-9), when E is received, match event combination expression according to the rank of n, till SGₖ₂=X_{1,1}X_{2,1} is matched, thus SGₖ₂ is true. Since X₃ is not included in E, According to Claim 2-11), input and output of X₃ are eliminated. In the end, FIG. 3 is simplified as FIG. 4 (wherein the colors of states can be self-defined).

Based on FIG. 4, according to Claims 1(1) and 2-12), we have

$$\begin{matrix}Pr \{ {H}_{kj} \vert E \} = Pr \{ {B}_{kj} \vert E \} \\ = Pr \{ {BX}_{kj} \vert E \} \\ = Pr \{ {SA}_{kj ; k 2} {B}_{kj} \vert {X}_{1 , 1} {X}_{2 , 1} \} \\ = \frac{Pr \{ {SA}_{kj ; k 2} {B}_{kj} {X}_{1 , 1} {X}_{2 , 1} \}}{Pr \{ {X}_{1 , 1} {X}_{2 , 1} \}} \\ = \frac{Pr \{ {SA}_{kj ; k 2} {B}_{kj} \} Pr \{ {X}_{1 , 1} {X}_{2 , 1} \}}{Pr \{ {X}_{1 , 1} {X}_{2 , 1} \}} \\ = Pr \{ {SA}_{kj ; k 2} {B}_{kj} \} \\ = {sa}_{kj ; k 2} {b}_{kj}\end{matrix}$$

when j=0, Pr{Hₖ₀|E}=sa_{k0;k2}bₖ₀=“-”×“-”=“-”,
when j=1, Pr{Hₖ₁|E}=sa_{k1;k2}bₖ₁=10×0.01=0.1,
when j=2, Pr{Hₖ₂|E}=sa_{k2;k2}bₖ₂=2×0.002=0.004.

Adopt the operator “*” defined in DUCG, the above calculations can be abbreviated as follows:

$$\begin{matrix}Pr \{ {H}_{k} \vert E \} = Pr \{ {B}_{k} \vert E \} \\ = Pr \{ {BX}_{kj} \vert E \} \\ = Pr \{ {SA}_{k ; k 2} * {B}_{k} \vert {X}_{1 , 1} {X}_{2 , 1} \} \\ = \frac{Pr \{ ( {SA}_{k ; k 2} * {B}_{k} ) {X}_{1 , 1} {X}_{2 , 1} \}}{Pr \{ {X}_{1 , 1} {X}_{2 , 1} \}} \\ = \frac{Pr \{ {SA}_{k ; k 2} * {B}_{k} \} Pr \{ {X}_{1 , 1} {X}_{2 , 1} \}}{Pr \{ {X}_{1 , 1} {X}_{2 , 1} \}} \\ = Pr \{ {SA}_{k ; k 2} * {B}_{kj} \} \\ = {sa}_{k ; k 2} * {b}_{k} \\ = ( \begin{matrix}- \\ 10 \\ 2\end{matrix} ) * ( \begin{matrix}- \\ 0.01 \\ 0.002\end{matrix} ) \\ = ( \begin{matrix}- \times - \\ 10 \times 0.01 \\ 2 \times 0.002\end{matrix} ) \\ = ( \begin{matrix}- \\ 0.1 \\ 0.004\end{matrix} )\end{matrix}$$

where the definition of operator “*” in DUCG is to conduct logic AND or to multiply the event/data in the same row of two matrices with a same number of rows (see Ref [6] for more details).

### Example 2

Except E=X_{1,0}, other conditions are the same with Example 1.

According to the rank of n and TABLE 1, SGₖ₀=X_{0,0}∪X_{2,0}X_{3,0} is matched. Thus FIG. 3 becomes FIG. 5.

As is claimed in Claim 2-10), Bₖ, SGₖ₀ and its input/output directed arcs are eliminated, resulting in FIG. 6. Assume X_{1,0} is the normal state of X₁, according to the simplification rules in DUCG, all variables in FIG. 6 are eliminated, i.e. FIG. 6 is eliminated, resulting in the elimination of Bₖ, i.e. the abnormal state of Bₖ does not exist, thus no further calculation is needed.

### Example 3

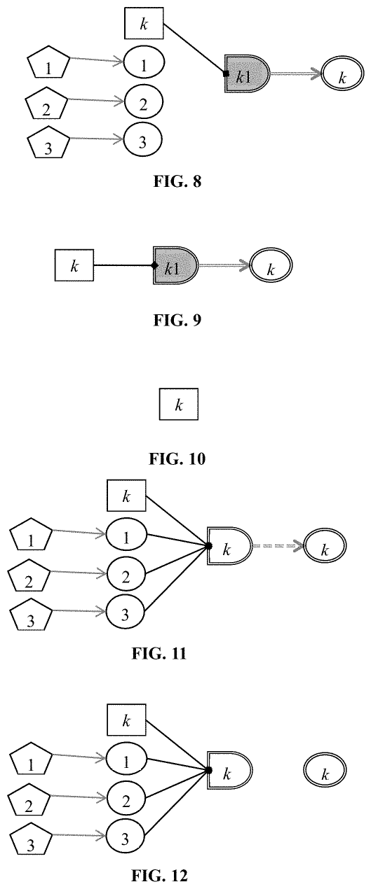

Except for that E=1, other conditions are the same with Example 1. E=1 means all the states of X₁, X₂, and X₃ are unknown so that only the remnant state in TABLE 1 is matched. Thus SGₖ₁ is matched, and FIG. 3 becomes FIG. 7. As is claimed in Claim 2-11), FIG. 7 is simplified as FIG. 8. Based on the simplification rules in DUCG, FIG. 8 is further simplified as FIG. 9.

Since SGₖ=SGₖ₁, we can see that from TABLE 1, sa_{k0;k1}=“-” and a_{k1;k1}=Sa_{k2;k1}=1. As is claimed in Claim 2-12), similar to the calculations in Example 1, we have

Pr{Hₖ₀|E}=sa_{k0;k2}bₖ₀=“-”×“-”=“-”;
Pr{Hₖ₁|E}=sa_{k1;k2}bₖ₁=1×0.01=0.01;
Pr{Hₖ₂|E}=sa_{k2;k2}bₖ₂=1×0.002=0.002.
In other words, the probability distribution of the state of BXₖ is exactly the same with that of Bₖ. In this case, Bₖ is exactly equal to BXₖ, thus we can substitute Bₖ for BXₖ. That means FIG. 9 can be further simplified as FIG. 10.

### Example 4

Change FIG. 3 as FIG. 11 with Z_{k;k}=X_{1,0}∪X_{2,0}X_{3,0} and E=X_{1,0}, while other conditions remain unchanged, in which the said directed arc in Claim 2-5) is represented by →.

According to Claim 2-5), Z_{k;k} is met conditioned on E, and SA_{k;k} is eliminated, FIG. 11 is changed as FIG. 12. Then based on the simplification rules in DUCG, the entire FIG. 12 (including Bₖ) is eliminated, and no further calculation is needed. This example is equivalent to Example 2 although with different representation modes, thus they have the same result.

### Example 5

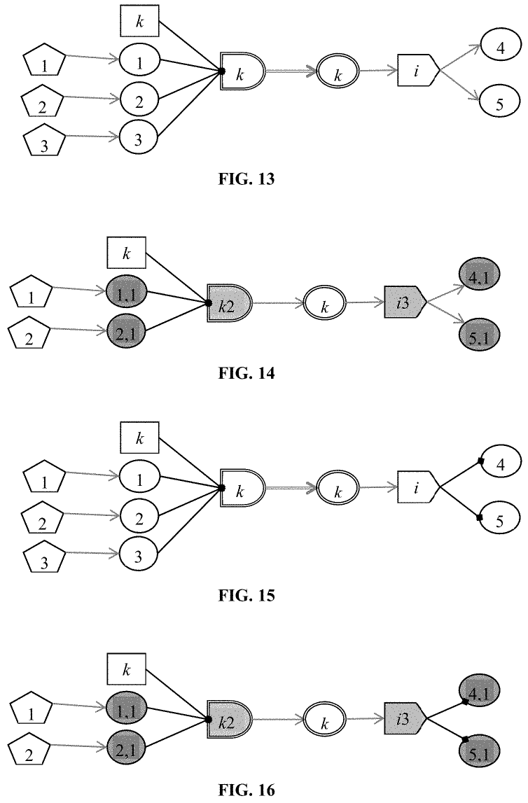

The reverse logic gate stated in Claims 1 and 3 is illustrated in FIG. 13, reversal logic gate RGᵢ is represented by graphical symbol [symbol] , RGᵢₙ is represented by graphical symbol [symbol] , BXₖ is the input of reversal logic gate RGᵢ, X₄ and X₅ are the outputs of RGᵢ=(RGᵢ₀ RGᵢ₁ RGᵢ₂)^{T}, the LGSᵢ is shown in TABLE 2.

TABLE 2
LGSᵢ in FIG. 13

| n | RGᵢₙ |
|---|---|
| 0 | Remnant state |
| 1 | X_{4, 1} |
| 2 | X_{5, 1} |
| 3 | X_{4, 1}X_{5, 1} |

Additionally, we have

$${a}_{i ; k} = ( \begin{matrix}- & - & - \\ - & 0.4 & 0.1 \\ - & 0.5 & 0.1 \\ - & 0.1 & 0.8\end{matrix} ) ,$$

the rank of n is 3, 2, 1 and 0, others are the same with Example 1.

According to Claim 3-6) and TABLE 2, the generated parameters a are

$${a}_{4 ; i} = ( \begin{matrix}- & - & - & - \\ - & 1 & 0 & 1\end{matrix} ) and {a}_{5 ; i} = ( \begin{matrix}- & - & - & - \\ - & 0 & 1 & 1\end{matrix} ) .$$

Assume E=X_{1,1}X_{2,1}X_{4,1}X_{5,1}, according to LGSᵢ, we have RGᵢ=RGᵢ₃, then FIG. 13 becomes FIG. 14. Based on FIG. 14, according to the DUCG expanding algorithm, we expand step by step from downstream to upstream:

$${X}_{4 , 1} = {F}_{4 , 1 ; i 3} R {G}_{i 3} = {A}_{4 , 1 ; i 3} R {G}_{i 3} with single input , r does not work . \\ {X}_{5 , 1} = {F}_{5 , 1 ; i 3} R {G}_{i 3} = {A}_{5 , 1 ; i 3} R {G}_{i 3}$$

$${X}_{4 , 1} {X}_{5 , 1} = {A}_{4 , 1 ; i 3} R {G}_{i 3} {A}_{5 , 1 ; i 3} R {G}_{i 3} = ( {A}_{4 , 1 ; i 3} * {A}_{5 , 1 ; i 3} ) R {G}_{i 3}$$

Since a_{4,1;i3}=a_{5,1;i3}=1, i.e. A_{4,1;i3}=A_{5,1;i3}=1, the above equation becomes:

$$\begin{matrix}{X}_{4 , 1} {X}_{5 , 1} = ( {A}_{4 , 1 ; i 3} * {A}_{5 , 1 ; i 3} ) R {G}_{i 3} \\ = R {G}_{i 3} \\ = {A}_{i 3 ; k} B {X}_{k} \\ = {A}_{i 3 ; k} ( S {A}_{k ; k 2} * {B}_{k} ) based on Claim 2 \text{-} 12 )\end{matrix}$$

For simplicity, operator “*” in DUCG is used, its definition is explained in Example 1.

Then,

$${X}_{1 , 1} = {F}_{1 , 1 ; 1 D} {D}_{1} = {A}_{1 , 1 ; 1 D} {D}_{1}$$

$${X}_{2 , 1} = {F}_{2 , 1 ; 2 D} {D}_{2} = {A}_{2 , 1 ; 2 D} {D}_{2}$$

$$\begin{matrix}E = {X}_{1 , 1} {X}_{2 , 1} {X}_{4 , 1} {X}_{5 , 1} \\ = {A}_{1 , 1 ; 1 D} {D}_{1} {A}_{2 , 1 ; 2 D} {D}_{2} {A}_{i 3 ; k} ( S {A}_{k ; k 2} * {B}_{k} )\end{matrix}$$

Assume Hₖⱼ=Bₖⱼ, then we have

$$\begin{matrix}Pr \{ {H}_{kj} \vert E \} = P r \{ {B}_{k} \vert E \} \\ = Pr \{ B {X}_{k} \vert E \} based on Claim 2 \text{-} 12 ) \\ = Pr \{ S {A}_{kj ; k 2} {B}_{kj} \vert E \} based on Claim 2 \text{-} 12 ) \\ = \frac{P r \{ S {A}_{kj ; k 2} {B}_{kj} E \}}{P r \{ E \}} \\ = \frac{P r \{ S {A}_{kj ; k 2} {B}_{kj} {A}_{1 , 1 ; 1 D} {D}_{1} {A}_{2 , 1 ; 2 D} {D}_{2} {A}_{i 3 ; k} ( S {A}_{k ; k 2} * {B}_{k} ) \}}{P r \{ {A}_{1 , 1 ; 1 D} {D}_{1} {A}_{2 , 1 ; 2 D} {D}_{2} {A}_{i 3 ; k} ( S {A}_{k ; k 2} * {B}_{k} ) \}} \\ = \frac{P r \{ {A}_{1 , 1 ; 1 D} {D}_{1} {A}_{2 , 1 ; 2 D} {D}_{2} {A}_{i 3 ; k 2} ( S {A}_{kj ; k 2} {B}_{kj} ) \}}{P r \{ {A}_{1 , 1 ; 1 D} {D}_{1} {A}_{2 , 1 ; 2 D} {D}_{2} {A}_{i 3 ; k} ( S {A}_{( k ; k 2 )} * {B}_{k} ) \}} \\ = \frac{{a}_{1 , 1 ; 1 D} {a}_{2 , 1 ; 2 D} {a}_{i 3 ; kj} ( s {a}_{kj ; k 2} {b}_{kj} )}{{a}_{1 , 1 ; 1 D} {a}_{2 , 1 ; 2 D} {a}_{i 3 ; k} ( s {a}_{k ; k 2} * {b}_{k} )} \\ = \frac{{a}_{i 3 , kj} ( s {a}_{kj ; k 2} {b}_{kj} )}{{a}_{i 3 ; k} ( s {a}_{k ; k 2} * {b}_{k} )}\end{matrix}$$

when j=0,

$$P r \{ {B}_{k 0} \vert E \} = \frac{{a}_{i 3 ; k 0} ( s {a}_{k 0 ; k 2} {b}_{k 0} )}{{a}_{i 3 , k} ( s {a}_{k ; k {2}^{*}} {b}_{k} )} = \frac{- \times ( 10 \times - )}{( - 0 \; 0.8 ) ( ( \begin{matrix}- \\ 10 \\ 2\end{matrix} ) * ( \begin{matrix}- \\ 0.01 \\ 0.002\end{matrix} ) )} = 0$$

when j=1,

$$Pr \{ {B}_{k 1} \vert E \} = \frac{{a}_{i 3 ; . k 1} ( s {a}_{k 1 ; k 2} {b}_{k 1} )}{{a}_{i 3 ; k} ( s {a}_{k ; k 2} * {b}_{k} )} = \frac{0.1 \times ( 10 \times 0.01 )}{( - 0.1 \; 0.8 ) ( ( \begin{matrix}- \\ 10 \\ 2\end{matrix} ) ( \begin{matrix}- \\ 0.01 \\ 0.002\end{matrix} ) )} = 0.7576$$

when j=2,

$$Pr \{ {B}_{k 2} \vert E \} = \frac{{a}_{i 3 ; k 1} ( s {a}_{k 2 ; k 2} {b}_{k 2} )}{{a}_{i 3 ; k} ( s {a}_{k ; k 2} * {b}_{k} )} = \frac{0.8 \times ( 2 \times 0.01 )}{( - 0.1 \; 0.8 ) ( \begin{matrix}- \\ 10 \\ 2\end{matrix} ) * ( \begin{matrix}- \\ 0.01 \\ 0.002\end{matrix} )} = 0.2424$$

### Example 6

As shown in FIG. 15, compared to FIG. 13, the output directed arc of RGᵢ is changed to be represented by [symbol] , a_{4;i} and a_{5;i} are eliminated, other conditions are the same with Example 5. Assume E=X_{1,1}X_{2,1}X_{4,1}X_{5,1}, according to LGSᵢ, we have RGᵢ=RGᵢ₃, then FIG. 15 becomes FIG. 16.

As is claimed in Claim 3-3), RGᵢ₃ is included into E as evidence to be expanded, in other words, E=X_{1,1}X_{2,1}X_{4,1}X_{5,1}RGᵢ₃. Since there is no F-type directed arc in the upstream of X_{4,1} and X_{5,1}, their expanding ends, the expanding of E=X_{1,1}X_{2,1}X_{4,1}X_{5,1}RGᵢ₃ is equivalent to that of E=X_{1,1}X_{2,1}RGᵢ₃. We also have X_{4,1}X_{5,1}=RGᵢ₃ in Example 5, thus the calculation results are exactly the same with Example 5.

### Example 7

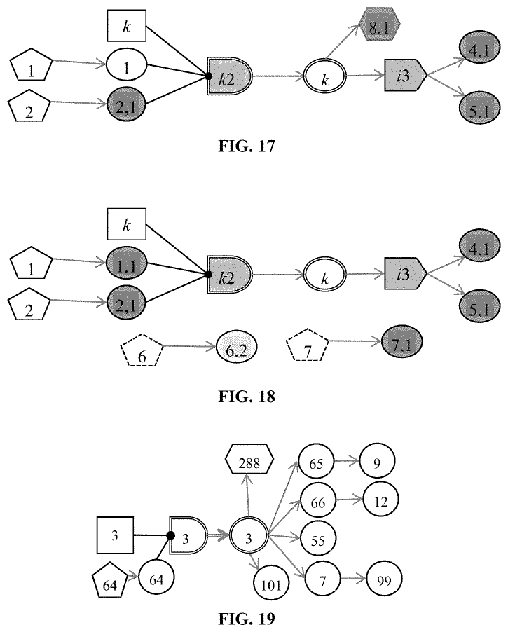

As shown in FIG. 17, we have E=X_{1,1}X_{2,1}X_{3,1}X_{4,1}X_{5,1}SX_{8,1}. Compared to FIG. 13, evidence X_{1,1} is deleted and specific evidence SX_{8,1} is added. Assume the state of Bₖ corresponding to SX_{8,1} is Bₖ₂ and θ_{8,1}=1. According to Claims 1 and 4, we get Pr{Bₖ₂|E}=1.

### Example 8

Example 8 is illustrated in FIG. 18.

The only difference between FIG. 18 and FIG. 13 is that FIG. 18 has two pieces of evidence X_{6,2} and X_{7,1} which cannot be explained by a B-type or BX-type variable. Assume a_{1,1;1,D}=0.4, a_{2,1;2D}=0.5 and score concern degree E according to centesimal grade, then the concern degree of X_{6,2} is ε_{6,2}=20, the concern degree of X_{7,1} is ε_{7,1}=10, take “equation that the bigger ε_{yg}, the smaller the value is”=1/ε_{yg}. According to Claim 5, we have S₁={X_{1,1}, X_{2,1}, X_{4,1}, X_{5,1}} and S₂={X_{6,2}, X_{7,1}}. Then,

$$\begin{matrix}{ζ}_{k} = Pr \{ {\prod }_{γ ' ∈ {S}_{1}} {E}_{{y}^{′}} \vert sub graph k \} {\prod }_{y ∈ {S}_{2}} ( expression that the bigger {ɛ}_{yg} , the smaller the value is ) \\ = Pr \{ {X}_{1 , 1} {X}_{2 , 1} {X}_{3 , 1} {X}_{4 , 1} \} \frac{1}{{ɛ}_{6 , 2}} \frac{1}{{ɛ}_{7 , 1}} \\ = Pr \{ {A}_{1 , 1 ; 1 D} {D}_{1} {A}_{2 , 1 ; 2 D} {D}_{2} {A}_{i 3 ; k} ( S {A}_{k ; k 2} * {B}_{k} ) \} \frac{1}{{ɛ}_{6 , 2}} \frac{1}{{ɛ}_{7 , 1}} see Example 5 for details \\ = {a}_{1 , 1 ; 1 D} {a}_{2 , 1 ; 2 D} {a}_{i 3 ; k} ( s {a}_{k ; k 2} * {b}_{k} ) \frac{1}{{ɛ}_{6 , 2}} \frac{1}{{ɛ}_{7 , 1}} \\ = 0.4 \times 0.5 ( - 0.1 \; 0.8 ) ( ( \begin{matrix}- \\ 10 \\ 2\end{matrix} ) * ( \begin{matrix}- \\ 0.01 \\ 0.002\end{matrix} ) ) \frac{1}{20} \times \frac{1}{10} \\ = 0.000014\end{matrix}$$

### Example 9

Consider 25 diseases that may cause the chief complaint nasal obstruction. They belong to five categories as shown in TABLE 3.

TABLE 3
25 DISEASES INCLUDED IN THE DUCG OF NASAL OBSTRUCTION

| Category | Variable | Disease description |
|---|---|---|
| Tumor lesion | B₂ | Nasal sinus malignancy (not including Ethmoid |
| | | sinus carcinoma and Carcinoma of maxillary sinus) |
| | B₇ | Nasopharyngeal angiofibroma |
| | B₈ | Inverted papilloma of the nose and sinuses |
| | B₁₅ | Carcinoma of nasopharyngeal |
| | B₂₁ | Carcinoma of ethmoid sinus |
| | B₂₂ | Carcinoma of maxillary sinus |
| | B₂₃₅ | Nasal hemangioma |
| Physical | B₁₃ | Fracture of nasal bone |
| injury | B₁₄ | Fracture of ethmoidal sin |
| | B₁₆ | Fracture of frontal sinus |
| Congenital | B₃ | Nasal septum deviation |
| aplasia | B₄ | Encephalomeningocele |
| | B₂₄₂ | Congenital atresia of the posterior nares |
| Inflammation | B₁ | Atrophic rhinitis |
| and Infection | B₁₀ | Mycotic maxillary sinusitis |
| | B₁₂ | Bleeding polyp |
| | B₁₉₈ | Acute sinusitis |
| | B₂₀₃ | Acute rhinitis |
| | B₂₀₈ | Allergic rhinitis |
| | B₂₁₇ | Chronic nasosinusitis |
| | B₂₃₇ | Chronic hypertrophic rhinitis |
| | B₂₃₉ | Adenoid hypertrophy |
| | B₂₃₈ | Chronic rhinosinusitis with nasal polyps |
| | B₂₄₀ | Chronic simple rhinitis |
| Foreign body | B₆ | Nasal foreign body |

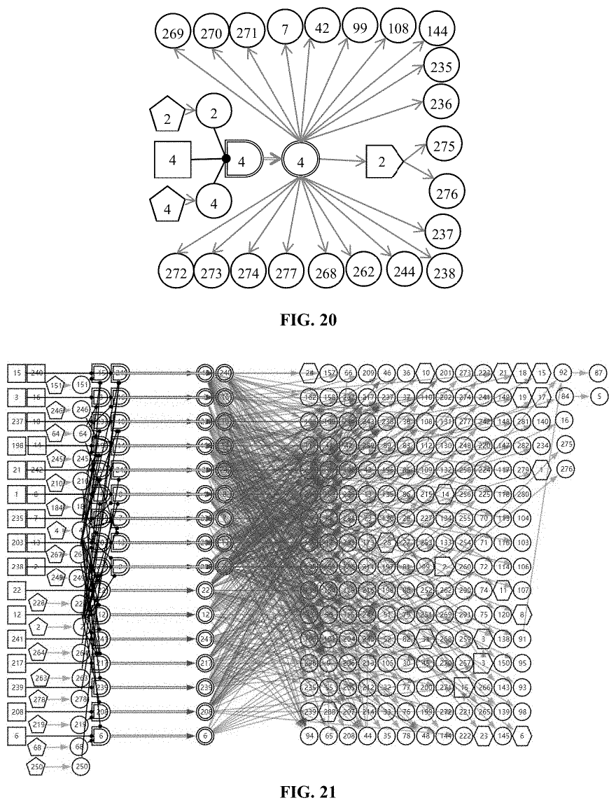

For each disease, a corresponding subgraph is constructed, where a subgraph is a part of the DUCG of nasal obstruction. As examples, two subgraphs of the 25 subgraphs are as shown in FIGS. 19 and 20 respectively, in which the methods included in Claims 1-5 are used. The other 23 subgraphs are similar and ignored for simplicity. Combine all the 25 subgraphs by fusing the same variables in different subgraphs, the final DUCG is constructed as shown in FIG. 21, which is the DUCG used in the disease diagnoses of nasal obstruction. FIG. 21 includes 25 B-type variables/diseases and the corresponding 25 BX-type variables, 25 SG-type variables, 3 RG-type variables, 200 X-type variables, 17 SX-type variables, 17 D-type variables, 25 SA-type variables/matrices (double line directed arcs) and 531 F-type variables/matrices (single line directed arcs).

In FIG. 19, B₃ denotes nasal septum deviation, X₆₄ is a risk factor of B₃. BX₃ and SG₃ represent the influence of risk factor X₆₄ to B₃. In LGS₃, SG_{3,1}X_{64,0}, SG_{3,2}=X_{64,1} and SG_{3,0}=“Remnant”. Other variables down-stream of BX₃ represent all consequences/effects possibly caused by BX₃. In particular, SX₂₈₈ (Sinus CT shows nasal septum bending) is a disease-specific manifestation variable. When SX_{288,1} is observed, nasal septum deviation B_{3,1} must be true, i.e. S_{288,1}=1. The other encoded parameters are as follows.

$${r}_{n ; i} = 1 , {b}_{3} = {( - 0.006 )}^{T} , {a}_{7 ; 3} = ( \begin{matrix}- & - \\ - & 0.7 \\ - & 0.29\end{matrix} ) , \\ {a}_{9 ; 65} = ( \begin{matrix}- & - \\ - & 0.8 \\ - & 0.15\end{matrix} ) , {a}_{12 ; 66} = ( \begin{matrix}- & - \\ - & 0.9\end{matrix} ) , \\ {a}_{55 ; 3} = ( \begin{matrix}- & - \\ - & 1\end{matrix} ) , {a}_{64 D} = ( - 1 ) , {a}_{65 ; 3} = ( \begin{matrix}- & - \\ - & 0.6\end{matrix} ) , \\ {a}_{66 ; 3} ( \begin{matrix}- & - \\ - & 0.6\end{matrix} ) , {a}_{99 ; 7} = ( \begin{matrix}- & - \\ - & 0.9 \\ - & 0.01\end{matrix} ) , \\ {a}_{101 ; 3} = ( \begin{matrix}- & - \\ - & 0.2 \\ - & 0.1\end{matrix} ) , {a}_{288 ; 3} = ( \begin{matrix}- & - \\ - & 1\end{matrix} ) , \\ {sa}_{3 ; 3} = ( \begin{matrix}- & - & - \\ 1 & 1 & 1.5\end{matrix} ) , {LGS}_{3} = ( \begin{matrix}0 & Remnant \\ 1 & {X}_{64 , 0} \\ 2 & {X}_{64 , 1}\end{matrix} ) , {ɛ}_{7 , 1} = 85 , \\ {ɛ}_{9 , 1} = {ɛ}_{9 , 2} = 50 , {ɛ}_{12 , 1} = 30 , {ɛ}_{55 , 1} = 20 , {ɛ}_{64 , 1} = 1 , \\ {ɛ}_{65 , 1} = 70 , {ɛ}_{66 , 1} = 70 , {ɛ}_{99 , 1} = {ɛ}_{99 , 2} = 35 , \\ {ɛ}_{101 , 1} = {ɛ}_{102 , 2} = 50 , {ɛ}_{228 , 1} = 95 , {θ}_{288 , 1} = 1.$$

TABLE 4 is the descriptions of {X-, SX-}-type variables in FIG. 19.

TABLE 4
{X-, SX-}-type variables in FIG. 19

| Variable | Variable description |
|---|---|
| X₇ | Nasal obstruction |
| X₉ | Hemorrhinia |
| X₁₂ | Headache |
| X₅₅ | Nasal septum bending (physical examination) |
| X₆₄ | History of external head injury |
| X₆₅ | Nasal mucosal erosion |
| X₆₆ | Partial compression of ipsilateral turbinate |
| X₉₉ | Progressive nasal congestion |
| X₁₀₁ | Volume of nasal bleeding |
| SX₂₂₈ | Nasal septum bending (sinuses CT) |

In FIG. 20, B₄ denotes encephalomeningocele, X₂ and X₄ are two risk factors of B₄. BX₄ and SG₄ represent the influence of risk factors X₂ and X₄ to B₄. TABLE 5 is the descriptions of X-type variables in FIG. 20.

TABLE 5
X-type variables in FIG. 20

| Variable | Variable description |
|---|---|
| X₂ | Sex |
| X₄ | Age |
| X₇ | Nasal obstruction |
| X₄₂ | Hyposmia |
| X₉₉ | Progressive nasal congestion |
| X₁₀₈ | Eyeball displacement |
| X₁₄₄ | Angulus oculi medialis spacing increase |
| X₂₃₅ | Nasopharynx visible tumor |
| X₂₃₆ | Nasopharynx visible tumor (Nasal endoscopy) |
| X₂₃₇ | Visible tumor in nasal cavity |
| X₂₃₈ | Visible tumor in nasal cavity (Nasal endoscopy) |
| X₂₄₄ | Rhinolalia clausa |
| X₂₆₂ | Buccal respiration |
| X₂₆₈ | Infant lactation difficulty |
| X₂₆₉ | Mental decline |
| X₂₇₀ | The root of the tumor is located at the top of the nasal or nasopharynx |
| X₂₇₁ | Cystic masses can be seen at the root of the nose |
| X₂₇₂ | Tumor transmittance experiment |
| X₂₇₃ | The Tumors increases with crying |
| X₂₇₄ | X-ray suggests skull base bone defect |
| X₂₇₅ | CT suggests skull base bone defect |
| X₂₇₆ | Herniated meninges and brain tissue |
| X₂₇₇ | MIR suggests meningeal brain swelling |

The parameters related to the method presented in this invention are as follows, while the others are similar to those given for FIG. 19 and are ignored for simplicity.

$${a}_{2 ; 4} = ( \begin{matrix}- & - \\ 0 & 1\end{matrix} ) for {F}_{2 ; 4} from {BX}_{4} to {RG}_{2} , \\ {a}_{275 ; 2} = ( \begin{matrix}0 & 0 \\ 0 & 1\end{matrix} ) {a}_{276 ; 2} = ( \begin{matrix}0 & 0 \\ 0 & 1\end{matrix} ) , \\ LG {S}_{2} = ( \begin{matrix}0 & Remnant \\ 1 & {X}_{275 , 1} {X}_{276 , 1}\end{matrix} ) , {ɛ}_{2 , 1} = 99 , {ɛ}_{275 , 1} = 85 , {ɛ}_{276 , 1} = 95 .$$

### Case 1:

A middle-aged male patient with no history of trauma, unilateral nasal congestion, persistent nasal obstruction, nasal itching, unilateral epistaxis, volume of nasal bleeding is less, deviation of nasal septum found by physical examination, other symptoms and physical signs are normal, no laboratory examination and imaging examination results provided. In other words, the abnormal evidence E′ of this patient is:

E′=X_{7,1}X_{9,1}X_{55,1}X_{101,1}X_{221,1}X_{286,1}

Some symptoms and physical signs are observed as in normal states included in E″; the other {X-, SX-}-type variables are state-unknown. Based on the above evidence, the possible diseases are computed and ranked as shown in TABLE 6, in which nasal septal deviation is correctly diagnosed by using the method presented in this invention and the existing methods given in the earlier published DUCG patents and papers listed in this invention.

TABLE 6
The Diagnostic Results of the Nasal Septum Deviation Case

| Disease Hₖⱼ = Bₖⱼ | Ranked h^{s}ₖⱼ |
|---|---|
| Nasal septal deviation | 46.266% |
| Inverted papilloma of the nose and sinuses | <0.01% |
| Hemorrhagic nasal polyps | <0.01% |
| Nasal hemangioma | <0.01% |
| Mycotic maxillary sinusitis | <0.01% |
| Allergic rhinitis | <0.01% |
| Nasopharyngeal angiofibroma | <0.01% |
| Nasal sinus malignancy | <0.01% |
| Carcinoma of maxillary sinus | <0.01% |
| Carcinoma of ethmoid sinus | <0.01% |
| Atrophic rhinitis | <0.01% |
| Chronic nasosinusitis | <0.01% |
| Encephalomeningocele | <0.01% |
| Carcinoma of nasopharyngeal | <0.01% |
| Chronic hypertrophic rhinitis | <0.01% |
| Chronic simple rhinitis | <0.01% |

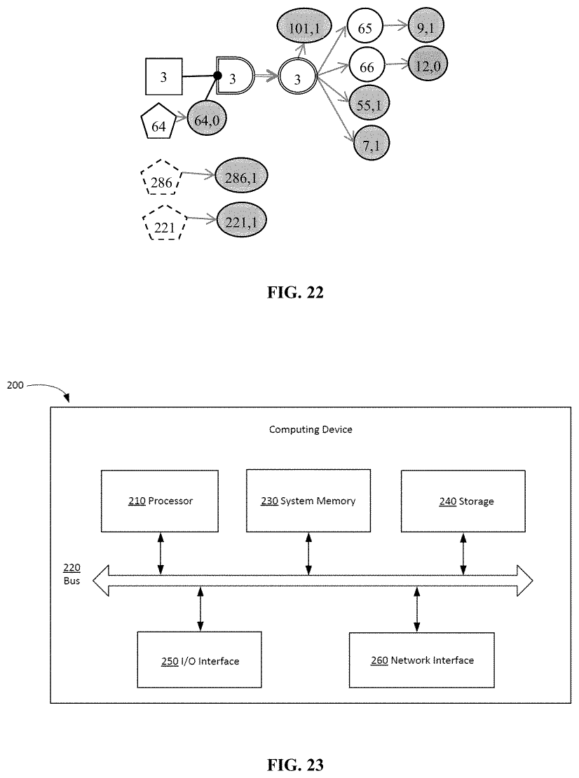

FIG. 22 explains this diagnostic result, in which color nodes indicate meaningful evidence including all E′ and X_{12,0} in E″ playing as the negative evidence.

### Case 2:

A one-year-old girl patient has the following symptoms: unilateral nasal congestion, snoring, nasal cavity mass found by physical examination, and nasal endoscopy. Imaging examination: CT suggests skull base bone defect, herniated meninges and brain tissue. In other words, the abnormal evidence E′ of this patient is:

E′=X_{2,1}X_{4,1}X_{7,1}X_{237,1}X_{238,1}X_{254,1}X_{275,1}X_{276,1}

The other symptoms and physical signs are state-normal. No laboratory test or imaging examination is made (state-unknown). The diseases are diagnosed and ranked as shown in TABLE 7, in which encephalomeningocele is correctly diagnosed.

TABLE 7
The Diagnostic Results of the Encephalomeningocele Case

| Disease Hₖⱼ = Bₖⱼ | Ranked h^{s}ₖⱼ |
|---|---|
| Encephalomeningocele | 50.658% |
| Nasal septum deviation | 4.509% |
| Chronic rhinosinusitis with nasal polyps | 3.653% |
| Nasal hemangioma | 2.11% |
| Inverted papilloma of the nose and sinuses | <0.01% |
| Hemorrhagic nasal polyp | <0.01% |
| Nasal sinus malignancy | <0.01% |
| Mycotic maxillary proinflammatory | <0.01% |
| Carcinoma of maxillary sinus | <0.01% |
| Carcinoma of ethmoid sinus | <0.01% |
| Chronic simple rhinitis | <0.01% |
| Atrophic rhinitis | <0.01% |
| Allergic rhinitis | <0.01% |
| Nasopharyngeal angiofibroma | <0.01% |
| Nasopharyngeal carcinoma | <0.01% |
| Acute sinusitis | <0.01% |
| Chronic nasosinusitis | <0.01% |
| Chronic hypertrophic rhinitis | <0.01% |

In the above calculations to get the diagnostic results, the methods included in Claims 1-5 and the methods in the patents and papers listed in this invention are used. Considering that examples 1-8 explain all the details of how to use these methods, the details of applying these methods in example 9 are ignored for simplicity.

The above described aspects of the disclosure have been described with regard to certain examples and embodiments, which are intended to illustrate but not to limit the disclosure. It should be appreciated that the subject matter presented herein may be implemented as a computer process, a computer-controlled apparatus or a computing system or an article of manufacture, such as a computer-readable storage medium.

Those skilled in the art will also appreciate that the subject matter described herein may be practiced on or in conjunction with other computer system configurations beyond those described herein, including multiprocessor systems, microprocessor-based or programmable consumer electronics, minicomputers, mainframe computers, handheld computers, special-purposed hardware devices, network appliances, and the like. The embodiments described herein may also be practiced in distributed computing environments, where tasks are performed by remote processing devices that are linked through a communications network. In a distributed computing environment, program modules may be located in both local and remote memory storage devices.

In at least some embodiments, a server or computing device that implements a portion or all of one or more of the technologies described herein may include a general-purpose computer system that includes or is configured to access one or more computer-accessible media. FIG. 23 illustrates such a general-purpose computing device 200. In the illustrated embodiment, computing device 200 includes one or more processors 210 (which may be referred herein singularly as “a processor 210” or in the plural as “the processors 210”) are coupled through a bus 220 to a system memory 230. Computing device 200 further includes a permanent storage 240, an input/output (I/O) interface 250, and a network interface 260.

In various embodiments, the computing device 200 may be a uniprocessor system including one processor 210 or a multiprocessor system including several processors 210 (e.g., two, four, eight, or another suitable number). Processors 210 may be any suitable processors capable of executing instructions. For example, in various embodiments, processors 210 may be general-purpose or embedded processors implementing any of a variety of instruction set architectures (ISAs), such as the x86, PowerPC, SPARC, or MIPS ISAs, or any other suitable ISA. In multiprocessor systems, each of processors 210 may commonly, but not necessarily, implement the same ISA.

System memory 230 may be configured to store instructions and data accessible by processor(s) 210. In various embodiments, system memory 230 may be implemented using any suitable memory technology, such as static random access memory (SRAM), synchronous dynamic RAM (SDRAM), nonvolatile/Flash-type memory, or any other type of memory.

In one embodiment, I/O interface 250 may be configured to coordinate I/O traffic between processor 210, system memory 230, and any peripheral devices in the device, including network interface 260 or other peripheral interfaces. In some embodiments, I/O interface 250 may perform any necessary protocol, timing, or other data transformations to convert data signals from one component (e.g., system memory 230) into a format suitable for use by another component (e.g., processor 210). In some embodiments, I/O interface 250 may include support for devices attached through various types of peripheral buses, such as a variant of the Peripheral Component Interconnect (PCI) bus standard or the Universal Serial Bus (USB) standard, for example. In some embodiments, the function of I/O interface 250 may be split into two or more separate components, such as a north bridge and a south bridge, for example. Also, in some embodiments some or all of the functionality of I/O interface 250, such as an interface to system memory 230, may be incorporated directly into processor 210.

Network interface 260 may be configured to allow data to be exchanged between computing device 200 and other device or devices attached to a network or network(s). In various embodiments, network interface 260 may support communication via any suitable wired or wireless general data networks, such as types of Ethernet networks, for example. Additionally, network interface 260 may support communication via telecommunications/telephony networks such as analog voice networks or digital fiber communications networks, via storage area networks such as Fibre Channel SANs or via any other suitable type of network and/or protocol.

In some embodiments, system memory 230 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media, such as magnetic or optical media, e.g., disk or DVD/CD coupled to computing device 200 via I/O interface 250. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 200 as system memory 230 or another type of memory.

Further, a computer-accessible medium may include transmission media or signals such as electrical, electromagnetic or digital signals, conveyed via a communication medium such as a network and/or a wireless link, such as may be implemented via network interface 260. Portions or all of multiple computing devices may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A method of construction and reasoning of an extended DUCG intelligent system for processing uncertain causal relationship information, by using a storage medium characterized in that: the storage medium stores computer programs, when the computer programs are executed, they can execute the method that, based on previous DUCG technical schemes, adds new methods to represent and reason the cause Bₖ of object system abnormality, which include (1) Use a new type of logic gate SGₖ and a new functional variable SA_{k;k} to represent the direct influences of evidence X_{yg} and its combinations on every state of Bₖ, Bₖ after the influences is denoted as BXₖ, X_{y} and Bₖ are inputs of SGₖ, and event matrix SA_{k;k} is the output of SGₖ, the member event of SA_{k;k} is SA_{kj;kn}; (2) Use reversal logic gate RGᵢ to represent the logic relationship between every state of cause variable and the state combination of more than one consequence variable, and determine the state of the reversal logic gate based on the meaningful state combination evidence of consequence variables, then make the DUCG reasoning according to the determined state of the reversal logic gate; (3) Use SX_{y} variable to represent the special X-type variable that corresponds to an abnormal state of a certain B-type variable, characterized in that when SX_{yg} (g≠0) is observed, it can be concluded that the corresponding abnormal state of the B-type variable is true without reasoning or calculating about SX_{yg}; (4) Use concern degree ε_{yg} (g≠0) of X_{yg} or SX_{yg} to represent the degree of the decreased likelihood when X_{yg} or SX_{yg} cannot be explained by a reasoning result Hₖⱼ, and includes ε_{yg} in the calculation of the state probability of Hₖⱼ, so that the more ε_{yg} included in the calculation and the bigger the value of ε_{yg}, the smaller the possibility of Hₖⱼ is; (5) Use danger degree μₖⱼ of abnormal state Bₖⱼ of Bₖ to represent the degree of Bₖⱼ to damage the object system, so that the bigger the value of μₖⱼ, the larger the demand to detect the states of X-type variables helpful to determine the state of Bₖ is.

2. As the said claim 1(1), which also characterized in that: 1) When Bₖ=Bₖⱼ, then BXₖ=BXₖⱼ and vice versa; 2) Use a graphical symbol to represent SGₖ, and a type of directed arc to represent the input relationship from Bₖ or X_{y} to SGₖ; 3) Use another type of directed arc to represent SA_{k;k} from SGₖ to BXₖ; 4) sa_{kj;kn}≡Pr{SA_{kj;kn}} represents the zoom ratio to increase or decrease Pr{Bₖⱼ} as Pr{BXₖⱼ}, sa_{kj;kn} is not restricted by Pr{SA_{kj;kn}}≤1; 5) SA_{k;k} can be a conditional event matrix, which is represented by a directed arc different from the directed arc in the said 3), pointing from SGₖ to BXₖ, the conditional event of SA_{k;k} is represented by Z_{k;k}, which is an observable event, when Z_{k;k} is not met, SA_{k;k} is eliminated, otherwise is kept as ordinary SA_{k;k}, 6) In the logic gate specification LGSₖ of SGₖ, use event combination expression indexed by n (n≠1) to represent the X-type input event combination of SGₖₙ; 7) When n=1, the input event combination of SGₖ₁ is the remnant state of other state combination of input variables, the remnant state can also be indexed by n≠1; 8) n is given to indicate the rank of priorities of expressions; 9) According to the X-type evidence collected on site, match the event combination expression according to the rank of n to determine SGₖ=SGₖₙ, stop the match once an event combination expression indexed by n is matched; 10) When the event combination expression indexed by a special n such as n=0 is matched, Bₖ does not exists, and Bₖ, SGₖ and its input/output directed arcs can be eliminated; 11) The directed arc pointing from the state-unknown or state-normal X-type variable not included in the matched event combination expression n to SGₖₙ, can be eliminated; 12) When the matched n is not the special index mentioned above, replace Pr{Bₖⱼ|E} with Pr{BXₖⱼ|E}, BXₖⱼ=SA_{kj;kn}Bₖⱼ, thus Pr {Bₖⱼ|E}=sa_{kj;kn}bₖⱼ, where E is the collected evidence.

3. As the said claim 1(2), which also characterized in that: 1) Use a graphical symbol to represent RGᵢ, with at least one input variable connected with an F-type directed arc pointing from the input variable to RGᵢ, and with at least two output variables connected with directed arcs pointing from RGᵢ to the output variables; 2) RGᵢₙ is the state of RGᵢ indexed by n, represents the output variable state combination indexed by n, and is denoted as event combination expression n; 3) In the process of reasoning, the DUCG logic expanding of RGᵢₙ is as an X-type variable; 4) When n is a special index such as 0, which means no meaningful state combination of output variables, then RGᵢ₀ and its input/output directed arcs are eliminated; 5) n is given to indicate the rank of the priorities of the output variable state combinations, when evidence E is received, match the state combination expression of RGᵢₙ according to the rank of n till matched to determine RGₖ=RGₖₙ; 6) The a parameters encoded in the output F-type directed arc of RGᵢ can be generated automatically according to the LGSᵢ of RGᵢ. The rule of generation is: Check if there exists X_{yg} in the event combination expression of RGᵢ, if yes then a_{yg;in}=1 that is A_{yg;in}=1, otherwise a_{yg;in}=0 or “-” which means A_{yg;in}=0.

4. As the said claim 1(3), which also characterized in that: use 1≥θ_{yg}>0 to denote how much confidence of SX_{yg} to determine that an abnormal state of Bₖⱼ, j≠0 (indicate abnormal state), is true directly. θ_{yg} is used as hₖⱼ^{s} to join the rank of possible hypotheses.

5. As the said claim 1(4), which also characterized in that: 1) ε_{yg} is included in the calculation of the state probability hₖⱼ^{s} of Hₖⱼ, only when Hₖⱼ cannot be the cause explaining X_{yg} or SX_{yg} in sub-DUCGₖ. 2) The way to include ε_{yg} in the calculation is: in the calculation of the weighting coefficient
$${ξ}_{k} = {ζ}_{k} / {\sum }_{k} {ζ}_{k}$$
in the sub-DUCGₖ containing Hₖⱼ, when calculating ζₖ,
$${ζ}_{k} = Pr \{ {\prod }_{{y}^{′} ∈ {S}_{1}} {E}_{{y}^{′}} \vert sub \text{-} D U C {G}_{k} \} {\prod }_{y ∈ {S}_{2}}$$
(expression that the bigger ε_{yg}, the smaller the value is), where S₁ represents the set of index of evidence that is explained by Hₖⱼ in the sub-DUCGₖ, and S₂ represents the set of index of X_{yg}-type or SX_{yg}-type evidence that is not explained by Hₖⱼ in the sub-DUCGₖ.

6. As the said claim 1(5), which also characterized in that: 1) When calculating the probability importance measurement ρᵢ of the Xᵢ variable to be detected, replace ωₖ with ωₖⱼ. 2) When calculating the probability importance measurement ρᵢ, put ωₖⱼ into the inner layer of subscript j in the formulas to calculate ρᵢ, which includes but are not limited to:
$${ρ}_{i} ( y ) = \frac{1}{{m}_{i} ( y )} {\sum }_{k ∈ {S}_{iK} ( y )} {ω}_{k} {\sum }_{j ∈ {S}_{kJ}} {\sum }_{g ∈ {S}_{iG} ( γ )} P r \{ {X}_{ig} \vert E ( y ) \} \vert Pr \{ {H}_{kj} \vert {X}_{ig} E ( y ) \} - P r \{ {H}_{kj} \vert E ( y ) \} \vert$$
is replaced with
$${ρ}_{i} ( y ) = \frac{1}{{m}_{i} ( y )} {\sum }_{k ∈ {S}_{i K} ( γ )} {\sum }_{{ }^{j ∈ {S}_{kJ}}} {ω}_{kj} {\sum }_{g ∈ {S}_{iG} ( γ )} P r \{ {X}_{ig} \vert E ( y ) \} \vert Pr \{ {X}_{ig} E ( y ) \} - P r \{ E ( y ) \} \vert or$$
$${ρ}_{i} ( y ) = \frac{1}{{m}_{i} ( y )} {\sum }_{k ∈ {S}_{iK} 〈 y )} \frac{1}{{J}_{k}} {\sum }_{{ }^{j ∈ {S}_{kJ}}} {ω}_{kj} {\sum }_{g ∈ {S}_{iG} ( y )} P r \{ {X}_{ig} \vert E ( y ) \} \vert Pr \{ {X}_{ig} E ( y ) \} - P r \{ E ( y ) \} \vert$$
where Jₖ denotes the number of abnormal states of Bₖ.
